(19) United States
(12) Patent Application Publication
(10) Pub. No.: US 2025/0346488 A1
(43) Pub. Date: Nov. 13, 2025

(54) METHOD FOR SYNGAS SUBSTITUTION TO SYNGAS GENERATOR BURNERS TO PREVENT SYNGAS GENERATOR TRIP

(71) Applicant: AIR LIQUIDE LARGE INDUSTRIES U.S. LP, Houston, TX (US)

(72) Inventors: Gary D. MILLER, Houston, TX (US); Phillip JAMES, Houston, TX (US)

(73) Assignee: AIR LIQUIDE LARGE INDUSTRIES U.S. LP, Houston, TX (US)

(21) Appl. No.: 18/658,281

(22) Filed: May 8, 2024

(51) Int. Cl. C01B 3/34; C01B 3/50

(52) U.S. Cl. CPC C01B 3/34; C01B 3/50; C01B 2203/0233; C01B 2203/0827; C01B 2203/1623; C01B 2203/1638; C01B 2203/1685

(57) ABSTRACT

A method for operating a plant during an upset condition is provided. The plant includes a hydrogen plant having a syngas generator, a syngas separation unit having one or more of a pressure swing adsorption, temperature swing adsorption, or membrane system, and a carbon dioxide removal system having one or more of a syngas separation unit tail gas dryer/compressor, a cryogenic cold box, a membrane separator, and a carbon dioxide compression unit. The method for operating the plant when the carbon dioxide removal system is off-line includes introducing a process feed stream and a burner fuel stream into the syngas generator, thereby producing a flue gas stream and a syngas stream; introducing the syngas stream into the syngas separation unit, thereby producing a hydrogen product stream and a syngas separation unit tail gas stream; and bypassing the off-line carbon dioxide removal system and combining at least a portion of the syngas separation unit tail gas with burner fuel stream.

### BACKGROUND

Modern industrial plants are often complex and delicately balanced combinations of functional subsystems. If all the subsystems are operating properly, the overall plant operates properly. However, should a subsystem go off-line, this imbalance will typically affect the rest of the plant and require an alternate operating mode.

In a typical modern hydrogen production facility, there is a synthesis gas generating portion, a syngas separation into hydrogen product portion, and a carbon dioxide removal and capture system. Methane rich off gas from the carbon dioxide removal system often provides a significant percentage of the burner fuel for the synthesis gas (syngas) generating portion. If the carbon dioxide removal and capture system goes off-line, the furnace may see a rapid drop in internal pressure which may result in a trip. Such a trip will then cause the entire hydrogen production facility to trip. There is a need in the industry for a method to prevent an entire hydrogen production facility from tripping during a carbon dioxide removal system trip.

### SUMMARY

A method for operating a plant during an upset condition is provided. The plant includes a hydrogen plant having a syngas generator and could include a syngas separation unit having one or more of a pressure swing adsorption, temperature swing adsorption, or membrane system, and a carbon dioxide removal system having one or more of: a syngas separation unit tail gas dryer/compressor, a cryogenic cold box, a membrane separator, and a carbon dioxide compression unit. The plant could also employ a different type of syngas separation process or CO2 absorbent media/process and this invention would also apply to such a system. The method for operating the plant when the carbon dioxide removal system is off-line includes introducing a process feed stream and a burner fuel stream into the syngas generator, thereby producing a flue gas stream and a syngas stream, introducing the syngas stream into a syngas separation unit, thereby producing a hydrogen product stream and the syngas separation unit tail gas stream; and bypassing the off-line carbon dioxide removal system and combining at least a portion of the syngas separation unit tail gas with burner fuel stream.

The plant may also include a furnace heat input controller, and a syngas separation unit tail gas fuel control valve. The method may also include sending a low heat input signal from the furnace heat input controller, during a carbon dioxide removal system shutdown condition, to the syngas separation unit tail gas fuel control valve; and adjusting the flow of the syngas separation unit tail gas stream to supplement the burner fuel stream and thereby correcting the low furnace heat input condition. The method may include the syngas separation unit tail gas stream control valve having a valve flow coefficient that has been programmed as a heat input tracker, thereby allowing the controller to correct any low furnace pressure condition. This may require a parallel valve, if a single valve cannot be designed to operate properly throughout the entire operating range. The heat input tracker programming may be operating as a background program during normal operation of the hydrogen plant in combination with the carbon dioxide removal system, in a non-upset condition.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a system for removing carbon dioxide and hydrogen from a syngas stream, as is known in the art.

FIG. 2 is a schematic representation of the system with the carbon dioxide removal system out of service, as is known in the art.

FIG. 3 is a schematic representation of a system for removing carbon dioxide and hydrogen from a syngas stream with the carbon dioxide removal system out of service, in accordance with one embodiment of the present invention.

FIG. 4 is a schematic representation of a system for removing carbon dioxide and hydrogen from a syngas stream, as is known in the art.

FIG. 5 is a schematic representation of the system with the carbon dioxide removal system out of service, as is known in the art.

FIG. 6 is a schematic representation of a system for removing carbon dioxide and hydrogen from a syngas stream with the carbon dioxide removal system out of service, in accordance with one embodiment of the present invention.

### ELEMENT NUMBERS

101=process feed stream
102=burner fuel stream
103=combined burner fuel stream
104=steam methane reformer
105=raw syngas stream
106=water-gas shift converter
107=shifted syngas stream
108=syngas cooler
109=cooled shifted syngas
110=combined cooled shifted syngas stream
111=syngas separation unit
112=hydrogen product stream
113=tail gas stream
114=carbon dioxide removal system
115=tail gas drying and compression unit
116=dried, compressed tail gas stream
117=cold box
118=carbon dioxide stream
119=carbon dioxide compression unit
120=carbon dioxide product stream
121=cold box residue stream
122=membrane separator
123=hydrogen rich stream
124=methane rich off gas stream
125=methane rich off gas control valve
201=first portion of tail gas stream (sent to flare)
202=tail gas pressure control valve
301=second portion of tail gas stream (sent to burner)
302=tail gas fuel control valve
505=furnace heat input controller

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

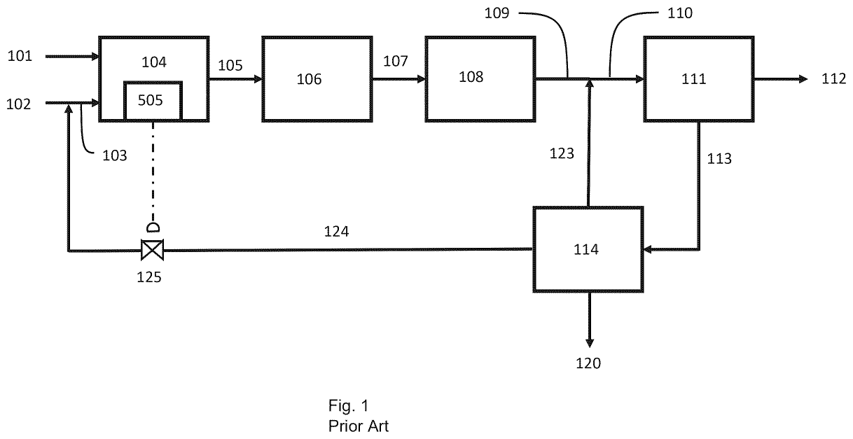

Turning to FIG. 1, a system for removing carbon dioxide and hydrogen from a syngas stream as is known is presented. Process feed stream 101 and burner fuel stream 102 are introduced into steam methane reformer 104, thereby producing raw syngas stream 105. Raw syngas stream 105 is introduced into water-gas shift converter 106, thereby producing shifted syngas stream 107. Shifted syngas stream 107 is introduced into syngas cooler 108, thereby producing cooled shifted syngas stream 109. Cooled shifted syngas stream 109 is combined with hydrogen rich stream 123 thereby producing combined cooled shifted syngas stream 110. Combined cooled shifted syngas stream 110 is introduced into syngas separation unit 111, thereby producing hydrogen product stream 112, and tail gas stream 113.

Tail gas stream 113 is introduced into carbon dioxide removal system 114, thereby producing hydrogen rich stream 123, methane rich off gas fuel stream 124, and carbon dioxide product stream 120. Methane rich off gas fuel stream 124 is combined with burner fuel stream 102 via methane rich off gas control valve 125. Hydrogen rich stream 123 is combined with cooled shifted syngas stream 109, thereby forming combined cooled shifted syngas stream 110.

Carbon dioxide removal system 114 may be any system known in the art. Such systems may include, but are not limited to, adsorption, CO2 scrubbers, molecular sieves, cryogenic separation, and/or membrane separation. The CO2 scrubber may utilize an amine (e.g. MEA, DEA) or a solvent (e.g. Rectisol or Selexol). In this description, the carbon dioxide removal system 114 is presented as a “black box”. One of ordinary skill in the art will be able to provide the required details to this “black box” in order to enable this design and produce a fully functioning system.

Syngas separation unit 111 may be any system known in the art. Such systems may include, but are not limited to, pressure swing adsorption, temperature swing adsorption, or membrane systems. In this description, syngas separation unit 111 is presented as a “black box”. One of ordinary skill in the art will be able to provide the required details to this “black box” in order to enable this design and produce a fully functioning system.

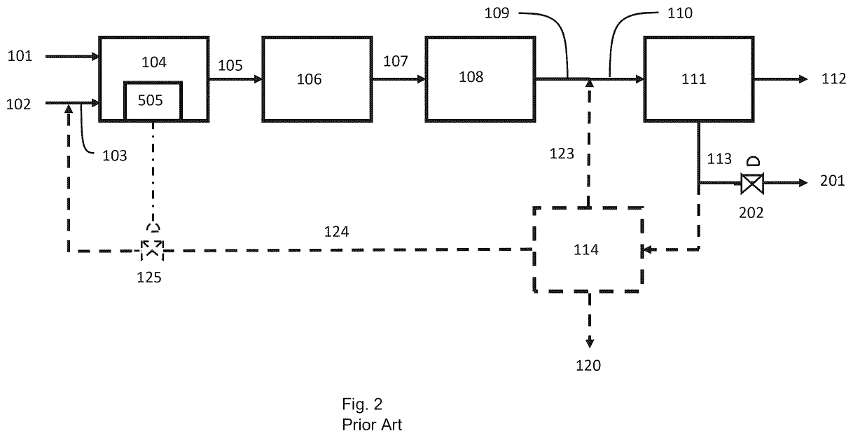

Turning to FIG. 2, the above system with the carbon dioxide removal system out of service is presented. In this scheme, during a carbon dioxide removal system trip, carbon dioxide removal system 114 is off-line. Burner fuel stream 102 is no longer combined with methane rich off gas stream 124. In this operating mode, process feed stream 101 and burner fuel stream 102 are introduced directly into steam methane reformer 104, thereby producing raw syngas stream 105. Raw syngas stream 105 is introduced into water-gas shift converter 106, thereby producing shifted syngas stream 107. Shifted syngas stream 107 is introduced into syngas cooler 108, thereby producing cooled shifted syngas stream 109. Cooled shifted syngas stream 109 is not combined with hydrogen rich stream 123. Cooled shifted syngas stream 109 is introduced into syngas separation unit 111, thereby producing hydrogen product stream 112, and tail gas stream 113. With no carbon dioxide removal system equipment operating downstream, tail gas stream 113 is sent to flare via tail gas pressure control valve 202. Such an operating mode, if it were prolonged, would be very inefficient. Additional process feed stream 101 flowrate and additional burner fuel stream 102 would be required to maintain the hydrogen product stream 112 flowrate, with a large amount of carbon dioxide entering the atmosphere unabated.

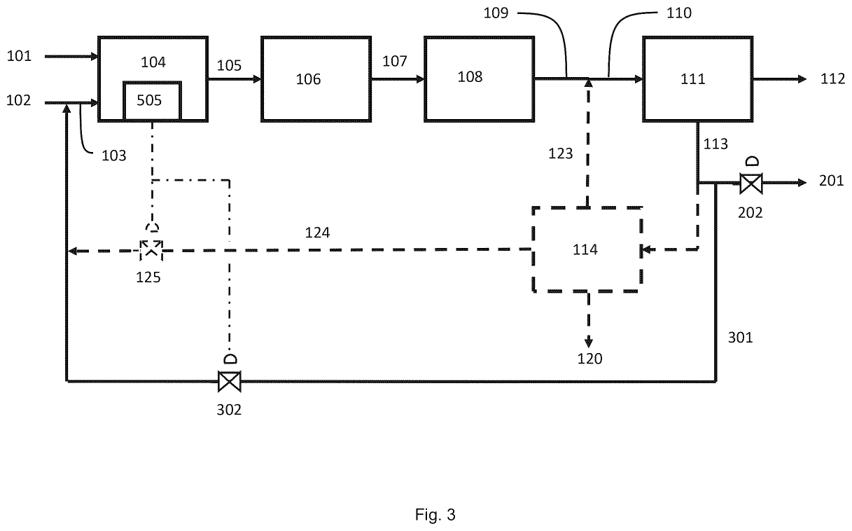

Turning to FIG. 3, a novel system for removing carbon dioxide and hydrogen from a syngas stream with the carbon dioxide removal system out of service is presented. In this scheme, carbon dioxide removal system 114 is off-line. During a carbon dioxide removal system trip, burner fuel stream 102 is combined with second portion 301 of syngas separation unit tail gas stream 113, via tail gas fuel control valve 302, thereby forming combined burner fuel stream 103. Process feed stream 101 and combined burner fuel stream 103 are introduced into steam methane reformer 104, thereby producing raw syngas stream 105. Raw syngas stream 105 is introduced into water-gas shift converter 106, thereby producing shifted syngas stream 107. Shifted syngas stream 107 is introduced into syngas cooler 108, thereby producing cooled shifted syngas stream 109. Cooled shifted syngas stream 109 is not combined with hydrogen rich stream 123. Cooled shifted syngas stream 109 is introduced into syngas separation unit 111, thereby producing hydrogen product stream 112, and tail gas stream 113.

With no carbon dioxide removal system equipment operating downstream, first portion 201 of tail gas stream 113 may be sent to flare, and second portion 301 of tail gas stream 113 may be combined with burner fuel stream 102, thereby forming combined burner fuel stream 103. The flowrate of second portion 301 is controlled by tail gas fuel control valve 302. Steam methane reformer 104 has furnace heat input controller 505, which sends a signal to control tail gas fuel control valve 302. During normal operation, this system operates in the background. But during a trip of the carbon dioxide removal system, as the heat input to the furnace is reduced, furnace heat input controller 505 will then send a signal to begin to open tail gas fuel control valve 302. Additional heat input from tail gas stream 113 will then be directed to the furnace. In this system, the heat input requirement for the steam methane reformer furnace can be maintained at approximately the normal operation levels, thus avoiding a trip of steam methane reformer 104.

The heat input can be adjusted to approximately match the normal duty of the furnace, and thus prevent the furnace from tripping. The tail gas fuel control valve flow coefficient (Cv) curve can be programmed to function as a “Heat Input Tracker”. This “Heat Input Tracker” can remain in the background when the overall system is operating normally. Then when the carbon dioxide removal system equipment trips, the “Heat Input Tracker” can spring into action, setting the control valve's controller output percentage to the proper setting to match the heat input requirement of the furnace. Then the furnace can operate under normal pressure control and avoid a trip. The benefits are: (1) To prevent the steam methane reformer furnace from tripping on either high-high (HH) pressure or low-low (LL) pressure excursions; and (2) Prevent flue gas & reformed gas heat recovery sections from tripping on either high-high (HH) temperature excursion or low-low (LL) temperature excursions.

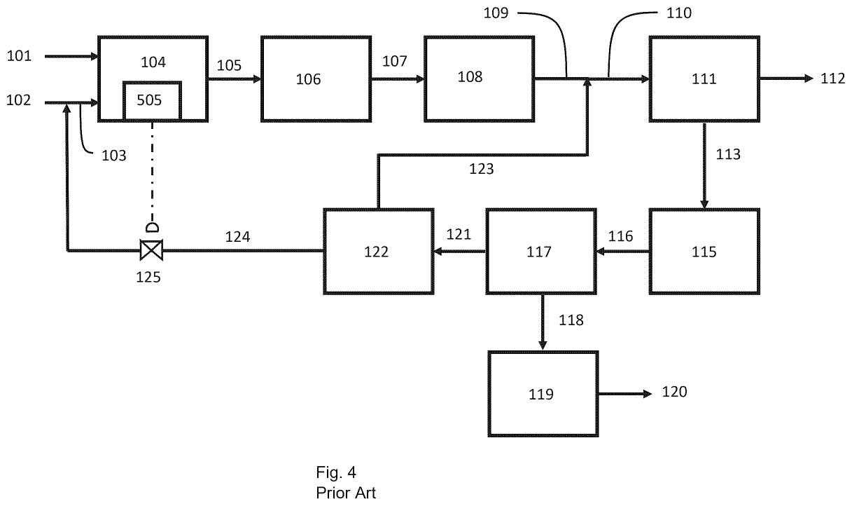

Turning to FIG. 4, one specific, but not limiting, embodiment of a system for removing carbon dioxide and hydrogen from a syngas stream as is known is presented. Burner fuel stream 102 is combined with methane rich off gas stream 124, thereby forming combined burner fuel stream 103. Process feed stream 101 and combined burner fuel stream 103 are introduced into steam methane reformer 104, thereby producing raw syngas stream 105. Raw syngas stream 105 is introduced into water-gas shift converter 106, thereby producing shifted syngas stream 107. Shifted syngas stream 107 is introduced into syngas cooler 108, thereby producing cooled shifted syngas stream 109. Cooled shifted syngas stream 109 is combined with hydrogen rich stream 123 thereby producing combined cooled shifted syngas stream 110. Combined cooled shifted syngas stream 110 is introduced into syngas separation unit 111, thereby producing hydrogen product stream 112, and tail gas stream 113.

Tail gas stream 113 is introduced into tail gas drying and compression unit 115, thereby producing dried, compressed tail gas stream 116. Dried, compressed tail gas stream 116 is introduced into cold box 117, thereby producing carbon dioxide stream 118 and cold box residue stream 121. Carbon dioxide stream 118 is introduced into carbon dioxide compression unit 119, thereby producing carbon dioxide product stream 120. Cold box residue stream 121 is introduced into membrane separator 122, thereby producing methane rich off gas stream 124 and hydrogen rich stream 123. Methane rich off gas stream 124 is combined with burner fuel stream 102 via methane rich off gas control valve 125. Hydrogen rich stream 123 is combined with cooled shifted syngas stream 109, thereby forming combined cooled shifted syngas stream 110.

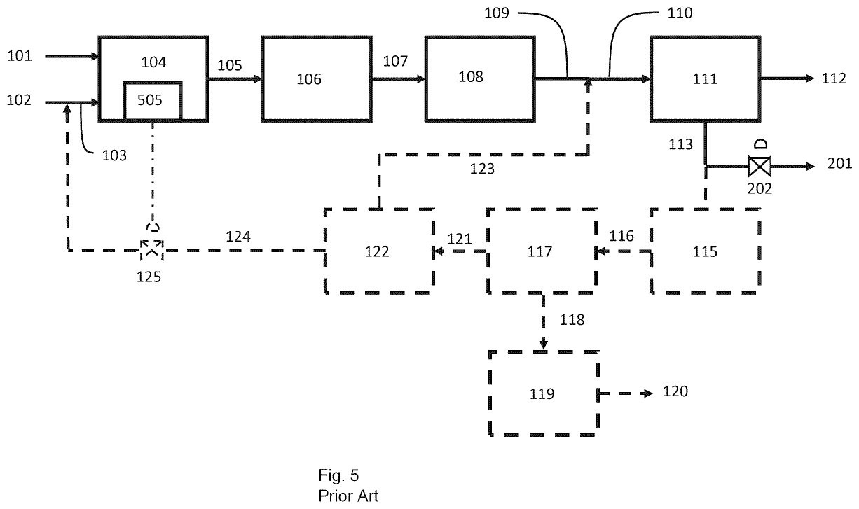

Turning to FIG. 5, the above system with the carbon dioxide removal system out of service is presented. In this scheme, during a carbon dioxide removal system trip, tail gas drying and compression unit 115, cold box 117, carbon dioxide compression unit 119, and membrane separator 122 are off-line. Burner fuel stream 102 is no longer combined with methane rich off gas stream 124. In this operating mode, process feed stream 101 and burner fuel stream 102 are introduced directly into steam methane reformer 104, thereby producing raw syngas stream 105. Raw syngas stream 105 is introduced into water-gas shift converter 106, thereby producing shifted syngas stream 107. Shifted syngas stream 107 is introduced into syngas cooler 108, thereby producing cooled shifted syngas stream 109. Cooled shifted syngas stream 109 is not combined with hydrogen rich stream 123. Cooled shifted syngas stream 109 is introduced into syngas separation unit 111, thereby producing hydrogen product stream 112, and tail gas stream 113. With no carbon dioxide removal system equipment operating downstream, tail gas stream 113 is sent to flare via tail gas pressure control valve 202. Such an operating mode, if it were to be prolonged, would be very inefficient. Additional process feed stream 101 flowrate and additional burner fuel stream 102 flowrate would be required to maintain the hydrogen product stream 112 flowrate, with a large amount of carbon dioxide entering the atmosphere unabated.

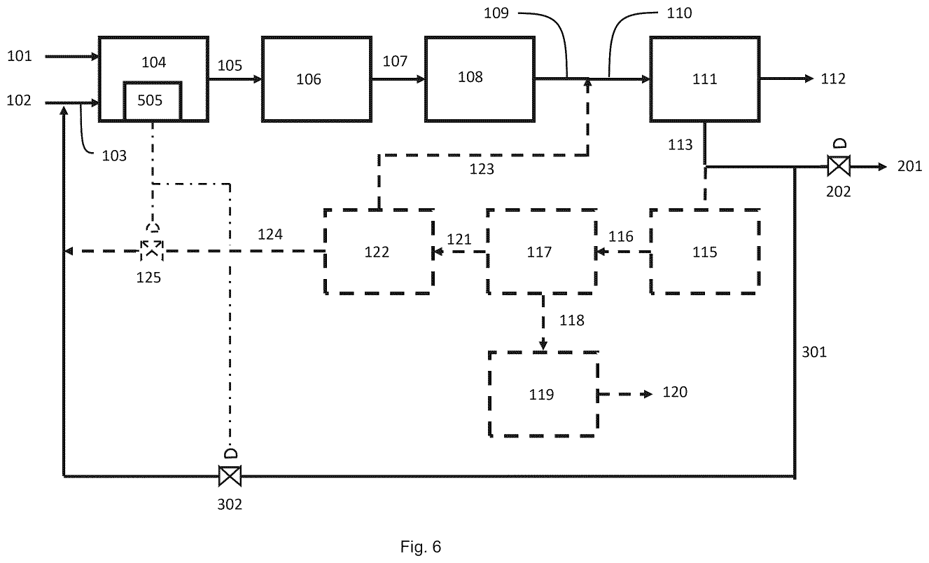

Turning to FIG. 6, a novel system for removing carbon dioxide and hydrogen from a syngas stream with the carbon dioxide removal system out of service is presented. In this scheme, tail gas drying and compression unit 115, cold box 117, carbon dioxide compression unit 119, and membrane separator 122 are off-line. During a carbon dioxide removal system trip, burner fuel stream 102 is combined with second portion 301 of tail gas stream 113, via tail gas fuel control valve 302, thereby forming combined burner fuel stream 103. Process feed stream 101 and combined burner fuel stream 103 are introduced into steam methane reformer 104, thereby producing raw syngas stream 105. Raw syngas stream 105 is introduced into water-gas shift converter 106, thereby producing shifted syngas stream 107. Shifted syngas stream 107 is introduced into syngas cooler 108, thereby producing cooled shifted syngas stream 109. Cooled shifted syngas stream 109 is not combined with hydrogen rich stream 123. Cooled shifted syngas stream 109 is introduced into syngas separation unit 111, thereby producing hydrogen product stream 112, and tail gas stream 113.

With no carbon dioxide removal system equipment operating downstream, first portion 201 of tail gas stream 113 may be sent to flare, and second portion 301 of tail gas stream 113 may be combined with burner fuel stream 102. The flowrate of second portion 301 is controlled by tail gas fuel control valve 302. Steam methane reformer 104 has furnace heat input controller 505, which sends a signal to control tail gas fuel control valve 302. During normal operation, this system operates in the background. But during a trip of the carbon dioxide removal system, as the heat input to the furnace is reduced, the furnace heat input controller 505 will then send a signal to begin to open tail gas fuel control valve 302. Additional heat input from tail gas stream 113 will then be directed into the furnace. In this system, the heat input requirement for the steam methane reformer furnace can be maintained at approximately the normal operation levels, and thus avoid a trip of steam methane reformer 104.

The heat input can be adjusted to approximately match the normal duty of the furnace, and thus prevent the furnace from tripping. The tail gas fuel control valve flow coefficient (Cv) curve can be programmed to function as a “Heat Input Tracker”. This “Heat Input Tracker” can remain in the background when the overall system is operating normally. Then when the carbon dioxide removal system equipment trips. the “Heat Input Tracker” can spring into action, setting the control valve's controller output percentage to the proper setting to match the heat input requirement of the furnace. Then the furnace can operate under normal pressure control and avoid a trip. The benefits are: (1) To prevent the steam methane reformer furnace from tripping on either high-high (HH) pressure or low-low (LL) pressure excursions; and (2) Prevent flue gas & reformed gas heat recovery sections from tripping on either high-high (HH) temperature excursion or low-low (LL) temperature excursions.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for operating a plant during an upset condition, the plant comprising:
a hydrogen plant comprising a syngas generator, and a syngas separation unit, and
a carbon dioxide removal system,
the method for operating the plant when the carbon dioxide removal system is off-line comprising:
introducing a process feed stream and a burner fuel stream into the syngas generator, thereby producing a flue gas stream and a syngas stream,.
introducing the syngas stream into the syngas separation unit, thereby producing a hydrogen product stream and a syngas separation unit tail gas stream, and
bypassing the off-line carbon dioxide removal system and combining at least a portion of the syngas separation unit tail gas with the burner fuel stream.

2. The method of claim 1, the hydrogen plant further comprising:
a furnace heat input controller and a syngas separation unit tail gas fuel control valve,
the method further comprising:
sending a low heat input signal from the furnace heat input controller, during a carbon dioxide removal system shutdown condition, to the syngas separation unit tail gas fuel control valve,
adjusting the flow of the syngas separation unit tail gas fuel stream to supplement the burner fuel stream and thereby correcting the low furnace heat input condition.

3. The method of claim 2, wherein the syngas separation unit tail gas fuel control valve has a valve flow coefficient that has been programmed as a heat input tracker, thereby allowing the controller to correct any low furnace pressure condition.

4. The method of claim 3, wherein the heat input tracker programming is operating as a background program during normal operation of the hydrogen plant in combination with the carbon dioxide removal system, in a non-upset condition.

5. The method of claim 1, wherein the syngas separation unit is selected from the group consisting of a pressure adsorption unit, a temperature swing adsorption unit, a membrane separator, or any combination thereof.

6. The method of claim 1, wherein the carbon dioxide removal system is selected from the group consisting of carbon dioxide adsorption system, carbon dioxide scrubbers, molecular sieves, cryogenic separation, membrane separation, or any combination thereof.

7. A method for operating a plant during an upset condition, the plant comprising:
a hydrogen plant comprising a syngas generator, a syngas separation unit, and
a carbon dioxide removal system comprising one or more of a syngas separation unit tail gas dryer/compressor, a cryogenic cold box, a membrane separator, and a carbon dioxide compression unit,
the method for operating the plant when the carbon dioxide removal system is off-line comprising:
introducing a process feed stream and a burner fuel stream into the syngas generator, thereby producing a flue gas stream and a syngas stream,.
introducing the syngas stream into the syngas separation unit, thereby producing a hydrogen product stream and a syngas separation unit tail gas stream, and
bypassing the off-line carbon dioxide removal system and combining at least a portion of the syngas separation unit tail gas with the burner fuel stream.

8. The method of claim 7, the hydrogen plant further comprising:
a furnace heat input controller and a syngas separation unit tail gas fuel control valve,
the method further comprising:
sending a low heat input signal from the furnace heat input controller, during a carbon dioxide removal system shutdown condition, to the syngas separation unit tail gas fuel control valve,.
adjusting the flow of the syngas separation unit tail gas fuel stream to supplement the burner fuel stream and thereby correcting the low furnace heat input condition.

9. The method of claim 8, wherein the syngas separation unit tail gas fuel control valve has a valve flow coefficient that has been programmed as a heat input tracker, thereby allowing the controller to correct any low furnace pressure condition.

10. The method of claim 9, wherein the heat input tracker programming is operating as a background program during normal operation of the hydrogen plant in combination with the carbon dioxide removal system, in a non-upset condition.
